(19) United States
(12) Patent Application Publication
(10) Pub. No.: US 2026/0340125 A1
(43) Pub. Date: Oct. 29, 2026

(54) SYSTEM AND METHOD FOR DETECTING ANOMALOUS ENCRYPTION

(71) Applicant: Druva Inc., Santa Clara, CA (US)

(72) Inventors: Ashish KARNIK, Pune, Maharashtra (IN); Anand Dinkar APTE, Pune, Maharashtra (IN)

(21) Appl. No.: 19/301,672

(22) Filed: Aug. 15, 2025

(30) Foreign Application Priority Data
Oct. 21, 2024 (IN) 202441079964

(51) Int. Cl. G06F 21/56

(52) U.S. Cl. CPC G06F 21/562

(57) ABSTRACT

A malware detection system for detection of malware affected data is provided. The system includes a statistical module that is configured to perform a statistical analysis on plurality of backup files stored in a data storage device. The statistical module is further configured to determine a statistical deviation between consecutive backup cycles and to identify a set of files with the statistical deviation more than a predefined threshold value. The system further includes an anomaly detection module coupled to the statistical module. The anomaly detection module is configured to determine the compressibility for each file in the identified set of files and compare the compressibility to a compressibility threshold value. The anomaly detection module is further configured to tag a set of malware affected files; wherein malware affected files are identified as files with compressibility lower than the compressibility threshold value.

### PRIORITY STATEMENT

The present application claims priority under 35 U.S.C. §119 to Indian patent application number 202441079964 filed Oct. 21, 2024 the entire contents of which are hereby incorporated herein by reference.

### BACKGROUND

The invention generally relates to the field of detecting malicious activity and more particularly to, a system and method for anomalous encryption.

In the current digital landscape, data security has become increasingly critical as organizations and individuals rely heavily on digital storage. Cyber threats, including malware, are constantly evolving, posing significant risks to data integrity and confidentiality. Traditional methods of detecting malware, primarily based on signature-based detection, have been the cornerstone of cybersecurity for many years. These methods work by comparing files or programs against a database of known malware signatures. However, the effectiveness of signature-based detection is limited by its reliance on known signatures, making it inadequate for identifying new, unknown, or polymorphic malware that can change its appearance to evade detection.

Backup systems are essential for ensuring data recovery and protection. They provide a safeguard against data loss due to accidental deletion, hardware failures, or ransomware attacks. Despite their critical role, backup systems are not immune to malware attacks. When malware infects backup files, it compromises the reliability of the backups, making them unsafe for recovery and potentially spreading the infection further when these backups are restored.

Ransomware and malware typically target devices or storages by encrypting the stored data. Typically, an early indication to detect malware is to check whether the data has been encrypted. While data gets backed up on a regular basis depending on changes in data or metadata on device or storage, entropy is determined either at the source of backup or later on backup storage out of the backup window asynchronously. However, the process of checking data entropy either can add to system resource usage on backup source or extra resources may be needed on backup storage system. In the case of use of cloud resources for backup storage this check directly incurs cloud services cost.

Therefore, there is a need for a system and method to effectively detect anomalous encryption while minimizing costs and effectively using available resources.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a malware detection system for detection of malware activity is provided. The malware detection system comprises a statistical module configured to perform a statistical analysis on plurality of backup files stored in a data storage device. The statistical analysis is performed periodically for a plurality of backup cycles. The statistical module is further configured to determine a statistical deviation between consecutive backup cycles and identify a set of files with the statistical deviation more than a predefined threshold value. The set of files are a subset of the plurality of backup files. The malware detection system further includes an anomaly detection module coupled to the statistical module and configured to determine the compressibility for each file in the identified set of files compare the compressibility to a compressibility threshold value and tag a set of malware affected files. The malware affected files are identified as files with compressibility lower than the compressibility threshold value.

According to another example embodiment, a method for detecting malware activity is provided. The method comprises performing a statistical analysis on plurality of backup files stored in a data storage device; wherein the statistical analysis is performed periodically for a plurality of backup cycles. The method further includes determining a statistical deviation between consecutive backup cycles and identifying a set of files with the statistical deviation more than a predefined threshold value, The set of files are a subset of the plurality of backup files at current backup cycle. The method further includes determining the compressibility for each file in the identified set of files; comparing the compressibility to a compressibility threshold value and tagging a set of malware affected files. The malware affected files are identified as files with compressibility lower than the compressibility threshold value.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram illustrating the components of a malware detection system, according to some aspects of the present description;

FIG. 2 illustrates a flow chart of the process of detecting malware activity implemented according to aspects of the present technique;

FIG. 3 is a flow chart for building statistical heuristics implemented according to aspects of the present invention; and

FIG. 4 is a block diagram of an embodiment of a computing device in which a system for performing a backup operation, described herein, are implemented.

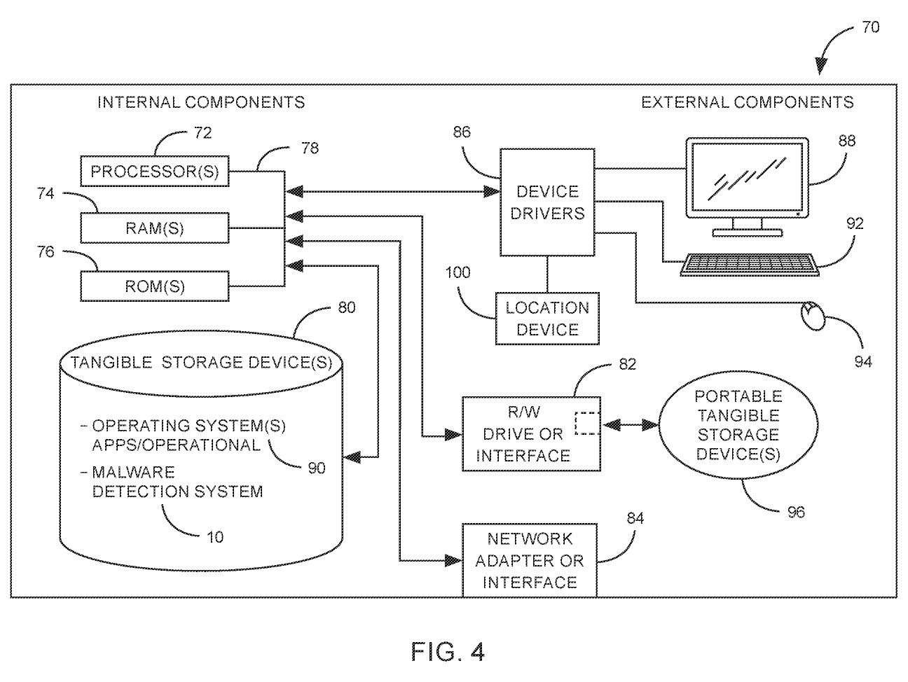

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently, or simultaneously. In addition, the order of operations may be re-arranged. The processes may be terminated when their operations are completed but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

Further, although the terms first, second, etc. may be used herein to describe various elements, components, regions, layers, and/or sections, it should be understood that these elements, components, regions, layers, and/or sections should not be limited by these terms. These terms are used only to distinguish one element, component, region, layer, or section from another region, layer, or a section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being "directly” connected, engaged, interfaced, or coupled to another element, there are no intervening elements present. Other words used to describe the relationship between elements should be interpreted in a like fashion (e.g., "between," versus "directly between," "adjacent," versus "directly adjacent," etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

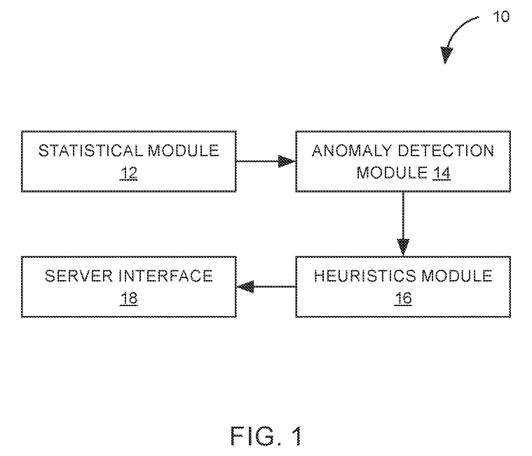

Example embodiments of the present invention provide systems and methods for detecting anomalous encryption. FIG. 1 is a block diagram 10 illustrating the components of a malware detection system to implement some embodiments of the invention. The malware detection system 10 includes a statistical module 12, an anomaly detection module 14, a heuristics module 16, and a server interface 18. Each component is described in further detail below.

Statistical module 12 is configured to perform statistical analyses on a plurality of backup files stored in a data storage device. The statistical module 12 operates periodically across multiple backup cycles, ensuring continuous monitoring and analysis to detect potential malware activity effectively. The periodicity of statistical analysis is configurable based on the specific requirements of the system 10, allowing for intervals such as daily, weekly, or monthly. The objective of this regular examination is to identify any unusual patterns or changes in the backup files that might indicate the presence of malware.

Statistical module 12 is further configured to determine a statistical deviation between consecutive backup cycles. In one embodiment, the statistical deviation is determined by comparing the data from a current backup cycle with the data from a previous cycle or cycles to identify any significant changes. The statistical deviation is calculated using statistical methods and metrics.

Upon determining the statistical deviation, the statistical module 12 is configured to identify a set of files for which the statistical deviation exceeds a predefined threshold value. This predefined threshold value is set to detect anomalies that are indicative of potential malware activity. The identified set of files, that exhibit deviations beyond the threshold, form a subset of the plurality of backup files. These files are flagged for further analysis and potential identification of malware activity.

Anomaly detection module 14 is coupled to the statistical module and configured to perform further analysis on the identified set of files. Specifically, the anomaly detection module 14 is configured to determine a compressibility of each file within the identified set of files. Compression ratio is defined as the ratio of the compressed size of a file to its original size. This process involves applying a standard compression algorithm such as zlib, zstandard to each file and measuring the resulting compressed size. As used herein, compressibility or efficiency of compression is an inverse of compression ratio.

Further, anomaly detection module 14 is further configured to compare these values to a predefined compressibility threshold value. In one embodiment, the threshold is established based on (a) empirical data and (b) historical compression ratios seen over multiple backup cycles for the files being backed up . It is chosen to effectively distinguish between typical benign files and potential encrypted files. Files with compressibility values below this threshold are considered suspicious

Additionally, the anomaly detection module 14 is configured to store the compressibility data for each file. The stored compressibility data is intended for use in future backup cycles, thereby enhancing the system's ability to detect evolving malware threats through historical analysis and pattern recognition.

Anomaly detection module 14 is further configured to tag files as potentially encrypted if their compressibility is lower than the compressibility threshold value. These tagged files are identified as encrypted files, as their low compressibility is indicative of characteristics commonly associated with files affected by malicious software, such as encrypted data. By performing these functions, the anomaly detection module 14 aids in the accurate identification of malware within the backup files.

This process complements the initial statistical analysis conducted by the statistical module 12. The statistical module's role in identifying files with significant deviations sets the stage for the anomaly detection module's more focused analysis. Together, these modules operate synergistically to provide a comprehensive and robust approach to detect malware activity. The integration of these sophisticated techniques ensures that the system not only identifies potential threats with greater precision but also minimizes the risk of false positives.

As a result, the overall efficacy of the malware detection system 10 is markedly enhanced. The combination of statistical deviation analysis and compressibility evaluation provides a multi-layered defense mechanism, offering a more thorough examination of the backup files. This integrated approach ensures a higher level of security and integrity for the data stored in the backup system, effectively safeguarding against a wide range of malware threats.

The malware detection system 10 also includes a heuristics module 16 that is coupled to the statistical module 12. The heuristics module 16 is configured to perform additional data aggregation and analysis to enhance the system's malware detection capabilities. Specifically, the heuristics module 16 is designed to aggregate a variety of parameters for the plurality of backup files. These parameters may include but are not limited to, file size, creation and modification timestamps, file type, frequency of access, and any other relevant metadata.

The aggregation of these parameters is performed across multiple backup cycles, allowing the system to compile comprehensive statistical data that reflect long-term trends and behaviors. The aggregation process involves collecting and organizing the parameters for each backup file over consecutive backup cycles. This longitudinal approach provides a detailed historical perspective on each file's characteristics and changes over time, facilitating the identification of anomalies that may indicate the malware activity.

The heuristics module 16 is further configured to compare the aggregated parameters for consecutive backup cycles. This comparative analysis helps to identify significant deviations or patterns that may not be immediately apparent in a single cycle but become evident when viewed over multiple cycles. By examining these differences, the heuristics module 14 can detect subtle indicators of malicious activity, such as gradual changes in file size or unexpected modifications. By incorporating the heuristics module's aggregated data and comparative analysis, the malware detection system 10 gains a more nuanced understanding of file behaviors and trends. This additional layer of analysis enhances the overall accuracy of the system, reducing the likelihood of false positives and improving the detection of sophisticated malware that may evade simpler detection methods.

The malware detection system 10 further includes a server interface 18. The server interface 18 is integrated with the anomaly detection module 14, enabling seamless communication and data transfer. Upon identification and tagging of potential encrypted files by the anomaly detection module 14, the server interface 18 promptly receives this information. The server interface 18 is configured to generate notifications for the system administrator. These notifications can be dispatched in various formats, including email alerts, SMS messages, or through a dedicated administrative dashboard. The notifications include detailed information about the identified encrypted files, such as file names, locations, and specific reasons for being flagged as potential threats.

The server interface 18 operates in real-time, ensuring immediate notification to the system administrator upon detection of malware activity. This enables the system administrator to take swift action to mitigate the threat, such as isolating the affected files, conducting further analysis, or initiating remediation procedures. In addition to notifications, the server interface 18 generates detailed reports that compile comprehensive data about the identified malware activity and encrypted files. These reports include statistical data, analysis results, and historical trends, providing context and insights into the nature of the threat. This detailed reporting assists the system administrator in making informed decisions and understanding the broader security implications.

By incorporating the server interface 18, the malware detection system 10 enhances its operational efficiency and response capabilities. The immediate and detailed notifications to the system administrator ensure that potential malware threats are addressed promptly and effectively, thereby maintaining the integrity and security of the backup files and the overall data storage environment.

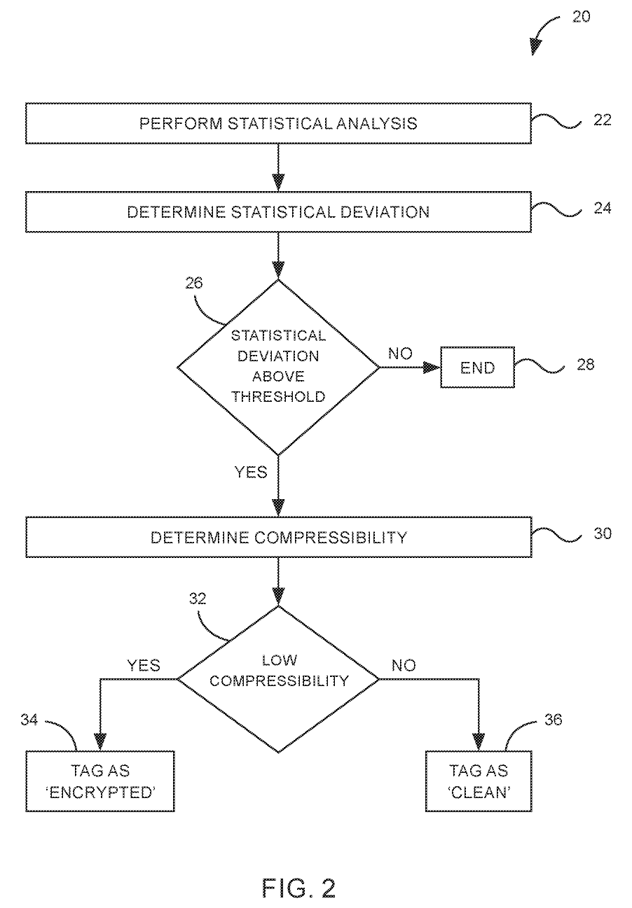

FIG. 2 is a flow chart 20 illustrating one process for detecting malware activity in data files implemented according to some embodiments of the invention. The process begins when a large number of files are backed up to a storage device. Each step of the process is described in further details below.

At block 22, a statistical analysis on a plurality of backup files stored in a data storage device is performed. The statistical analysis is conducted periodically across multiple backup cycles, ensuring continuous monitoring and evaluation of the backup files. Some of statistical analysis includes for example, identifying number of file data changed in a backup cycle, number of files moved from one folder location to another, number of files deleted.

At block 24, a statistical deviation is determined for each file, between consecutive backup cycles by comparing the statistical data from the current cycle with that from the previous cycle, using established statistical methods and metrics.

Based on the analysis, at step 26, a set of files is identified that exhibit a statistical deviation exceeding a predefined threshold value, indicating potential anomalies. These identified files form a subset of the plurality of backup files in the current backup cycle. If no files are found to exceed the predefined threshold value, the system concludes that no significant anomalies indicative of malware activity are present, and the analysis for that cycle ends (as shown at step 28). This ensures that only files exhibiting significant deviations are subjected to further scrutiny, optimizing the use of system resources.

For files that exceed the threshold, at step 30, compressibility for each file in the identified set is determined. In one embodiment, compressibility is calculated as the ratio between the compressed size of a file and its original size, providing a metric for identifying files that may contain obfuscated or encrypted data typical of malware activity. The determined compressibility of each file is then compared against a predefined compressibility threshold value to identify files with unusually low compressibility. Files with compressibility lower than this threshold are tagged at step 32, as potential malware files, marking them for further investigation or remedial action. If the compressibility of a file is not lower than the threshold value, the system stores the compressibility value of the file (as shown in step 34). This stored data enhances the system's ability to detect evolving malware threats through historical analysis and pattern recognition, providing a comprehensive metric for future backup cycles.

Additionally, the system aggregates a plurality of parameters for the backup files across multiple backup cycles to provide a comprehensive view of the data and to identify long-term trends and patterns. This is achieved using heuristics as described in detail below.

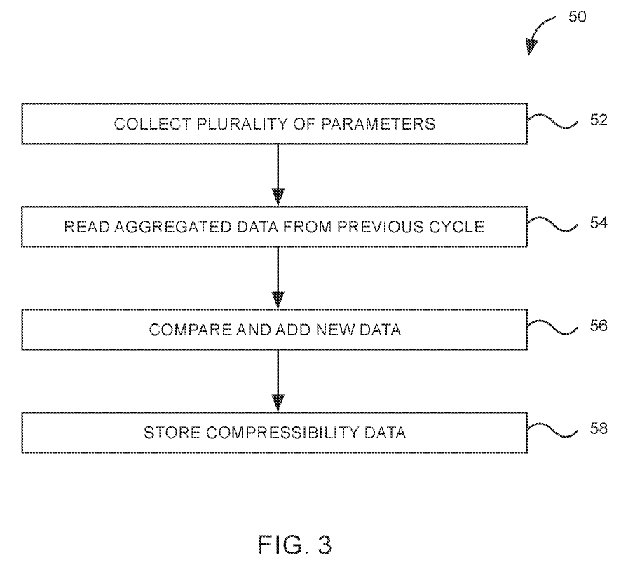

FIG. 3 is a flow chart illustrating one method by which heuristics is constructed, according to embodiments of the current invention.

At step 52, a plurality of parameters associated with a file is collected for a new cycle. In one embodiment, the parameters include statistical data, user data, device type, file type, compressibility of the file.

At step 54, the aggregated data of the file from the previous cycle is read. In one embodiment, the aggregated data is retrieved from database consisting of a plurality of parameters pertaining to previous backup cycle.

At step 56, the plurality of parameters associated with the new cycle is compared with the aggregated data of the previous cycle. Further, the plurality of parameters associated with the new cycle is added to existing statistics of the file for further use. At step 58, compressibility data of each file is stored. As described herein, the aggregated parameters are compared for consecutive backup cycles to detect gradual changes and trends that may indicate a slow-moving or evolving malware threat. Upon identifying potential files encrypted or otherwise tampered with by malware, the system notifies the system administrator of their presence to ensure prompt and appropriate actions are taken to mitigate the threats.

The malware detection system described herein is implemented using a computing device such as computing device 70 is described below in FIG. 5. The computing device 70 includes one or more processor(s) 72, one or more computer-readable RAMs 74 and one or more computer-readable ROMs 76 on one or more buses 78. Further, computing device 70 includes a tangible storage device 80 that may include system 10 for detecting malware. The various modules of the system 10 may be stored in the tangible storage device 80. Both, the operating systems 90 and the system 10 are executed by the one or more processor(s) 72 via one or more respective RAMs 74 (which typically include cache memory). The execution of the operating systems 90 and/or the system 10 by the one or more processor(s) configures the one or more processor(s) as a special purpose processor configured to carry out the functionalities of the operation systems) and/or the system 10 as described above.

Examples of the tangible storage device include semiconductor storage devices such as ROM, EPROM, flash memory or any other computer-readable tangible storage device that may store a computer program and digital information.

Computing device 70 also includes a R/W drive or interface 82 to read from and write to one or more portable computer-readable tangible storage devices 96 such as a CD-ROM, DVD, memory stick or semiconductor storage device. Further, network adapters or interfaces 84 such as a TCP/IP adapter cards, wireless Wi-Fi interface cards, or 3G or 4G wireless interface cards or other wired or wireless communication links are also included in computing device.

In one example embodiment, the system 10 may be stored in the tangible storage device and may be downloaded from an external computer via a network (for example, the Internet, a local area network or other, wide area network) and network adapter or interface.

Computing device 70 further includes device drivers 86 to interface with input and output devices. The input and output devices may include a computer display monitor 88, a keyboard 92, a keypad, a touch screen, a computer mouse 94, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to embodiments containing only one such recitation, even when the same claim includes the introductory phrases "one or more" or "at least one" and indefinite articles such as "a" or "an" (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of "two recitations," without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device main body or a removable medium arranged so that it may be separated from the computer device main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

What is claimed is:

1. A malware detection system for detection of malware activity, the malware detection system comprising:
a statistical module configured to:
perform a statistical analysis on plurality of backup files stored in a data storage device; wherein the statistical analysis is performed periodically for a plurality of backup cycles;
determine a statistical deviation between consecutive backup cycles; and
identify a set of files with the statistical deviation more than a predefined threshold value;
wherein the set of files are a subset of the plurality of backup files;
an anomaly detection module coupled to the statistical module and configured to:
determine the compressibility for each file in the identified set of files;
compare the compressibility to a compressibility threshold value; and
tag a set of malware affected files; wherein malware affected files are identified as files with compressibility lower than the compressibility threshold value.

2. The malware detection system of claim 1, further comprising a heuristics module coupled to statistical module and configured to aggregate a plurality of parameters for the plurality of backup files; wherein the plurality of parameters is aggregated across the plurality backup cycles.

3. The malware detection system of claim 2, wherein the heuristics module is further configured to compare the plurality of parameters for consecutive backup cycles.

4. The malware detection system of claim 1, further comprising a server interface coupled to the anomaly detection module and configured to notify a system administrator of the presence of set of malware affected files.

5. The malware detection system of claim 1; wherein the anomaly detection module is further configured to calculate a compressibility by determining a ratio between a compressed size of the file and an original size of the file.

6. The malware detection system of claim 5, wherein the inverse of the compressibility is a compression ratio.

7. The malware detection system of claim 1; wherein the compressibility for each file is stored for use in future backup cycles.

8. A method for detecting malware activity, the method comprising:
performing a statistical analysis on plurality of backup files stored in a data storage device;
wherein the statistical analysis is performed periodically for a plurality of backup cycles;
determining a statistical deviation between consecutive backup cycles; and
identifying a set of files with the statistical deviation more than a predefined threshold value;
wherein the set of files are a subset of the plurality of backup files at current backup cycle;
determining the compressibility for each file in the identified set of files;
comparing the compressibility to a compressibility threshold value; and
tagging a set of malware affected files; wherein malware affected files are identified as files with compressibility lower than the compressibility threshold value.

9. The method of claim 8; further comprising aggregating a plurality of parameters for the plurality of backup files; wherein the plurality of parameters is aggregated across the plurality backup cycles.

10. The method of claim 9, further comprising comparing the plurality of parameters for consecutive backup cycles.

11. The method of claim 9, notifying a system administrator of the presence of set of malware affected files.

12. The method of claim 8; wherein the compression ratio is calculated as a ratio between a compressed size of the file and an original size of the file.

13. The method of claim 12, wherein the inverse of the compressibility is a compression ratio.

14. The method of claim 8; further comprising storing wherein the compressibility for each file for use in future backup cycles.
